(19) United States
(12) Patent Application Publication
(10) Pub. No.: US 2009/0083537 A1
(43) Pub. Date: Mar. 26, 2009

(54) SERVER CONFIGURATION SELECTION FOR SSL INTERCEPTION

(75) Inventors: Case Thomas Larsen, San Francisco, CA (US); Shashidhar Merugu, Mountain View, CA (US); Paras Shah, Mountain View, CA (US); Naveen Maveli, Sunnyvale, CA (US)

Correspondence Address: PARK, VAUGHAN & FLEMING LLP, 2820 FIFTH STREET, DAVIS, CA, 95618, US

(73) Assignee: RIVERBED TECHNOLOGY, INC., San Francisco, CA (US)

(21) Appl. No.: 12/327,681

(22) Filed: Dec. 3, 2008

Related U.S. Application Data
(63) Continuation-in-part of application No. 11/489,414, filed on Jul. 18, 2006.
(60) Provisional application No. 60/992,067, filed on Dec. 3, 2007.
(60) Provisional application No. 60/707,804, filed on Aug. 10, 2005.

(51) Int. Cl. H04L 9/00

(52) U.S. Cl. 713/153

(57) ABSTRACT

A network intermediary device such as a transaction accelerator intercepts a client request for a secure communication connection with a server. The intermediary issues a substitute connection request to the server and receives a digital certificate during establishment of a secure communication session between the intermediary and the server. Based on information in the received digital certificate, the intermediary selects an appropriate operational configuration for responding to the client's request. The intermediary consults an ordered list or other collection of digital certificates it possesses, and chooses one having a common name that matches the server's common name. The match may comprise the first matching name, the longest match, the best match, the broadest match (e.g., a certificate having a name that includes one or more wildcard characters), etc. The intermediary then uses the selected certificate (and corresponding private key) to establish a secure communication session with the client.

### RELATED APPLICATIONS

The present application claims priority to U.S. Provisional Patent Application No. 60/992,067, which was filed Dec. 3, 2007, is entitled “Improved Server Configuration Selection for SSL Interception,” and is incorporated herein by reference. In addition, the present application is a continuation-in-part of U.S. patent application Ser. No. 11/489,414, which was filed Jul. 18, 2006 and is also incorporated herein by reference, and which claims priority to U.S. Provisional Patent Application No. 60/707,804, filed Aug. 10, 2005.

Yet further, the present application is related to U.S. patent application Ser. No. ______ [Attorney Docket RIV-0220], which was filed on the same date as the present application, is entitled “Reducing Latency of Split-Terminated Secure Communication Protocol Sessions,” and is incorporated herein by reference.

### FIELD

The present invention relates to network optimization in general, and in particular to configuring a network device to intercept a communication session secured via SSL, TLS or other comparable security protocol.

### BACKGROUND

Protocols that use either or both public-key cryptographic techniques and symmetric-key cryptographic techniques are often used to establish secure communications across an untrusted network or other communication link. Typically, public-key cryptography has better security properties but is more expensive computationally than symmetric-key cryptography. Thus, the two types of cryptography may be combined to use public-key techniques to negotiate a symmetric cipher between two entities. The symmetric-key cipher may then be used for bulk data transfer between the entities. Secure Socket Layer (SSL) and Transport Layer Security (TLS) are widely-used examples of secure communication protocols that have this form, as well as IPSec (Internet Protocol Security) when security associations are negotiated using RSA-based (Rivest, Shamir & Adleman) mechanisms for IKE (Internet (or IPsec) Key Exchange).

Secure communication protocols often add a computational cost to each secured connection. For server computers providing many simultaneous secure connections to client computers, the additional computational overhead imposed by secure communication protocols can be significant. To decrease the computational overhead of secure communication protocols for computers providing large numbers of secure connections, there are various devices that specialize in terminating secure connections. These secure connection termination devices manage the cryptographic and other security related aspects of the connection, thereby relieving server systems providing services to client systems of the additional overhead imposed by the secure connection. In general, these secure connection termination devices appear to client systems as servers providing secure connections.

From a security perspective, a secure connection termination device is similar to a server and therefore should be protected equally. If the security of a secure connection termination device is compromised, attackers could be able to set up a fake server that would be trusted by client systems that use the secure communication protocol.

A transaction accelerator such as that described in U.S. Pat. No. 7,120,666 (McCanne) can offer performance improvement for operations across a wide-area network (WAN), but only when the data being communicated is either intelligible (i.e., the transaction accelerator can interpret at least parts of the protocol) or repeating (i.e., identical data crosses the network in identical format). The use of secure communication protocols such as SSL and TLS thus typically frustrates transaction acceleration, because cryptography (by design) renders encrypted data unintelligible and non-repeating.

A method of securing end-to-end communications between a client and a server separated by transaction accelerators is described in U.S. Patent Publication No. US2007/0038853 (application Ser. No. 11/489,414), and involves the use of separate split-terminated secure protocol sessions between a transaction accelerator and the client and the server.

To enable such split-terminated secure protocol sessions, a transaction accelerator must be able to establish secure communication sessions with a client. However, in order to terminate such sessions on behalf of multiple servers, a transaction accelerator must be configured properly so as to operate correctly yet with sufficient flexibility to support each server as needed.

### SUMMARY

In some embodiments of the invention, a network intermediary device such as a transaction accelerator intercepts a client request for a secure communication connection with a server. The intermediary issues a substitute connection request to the server and receives a digital certificate as part of the procedure for establishing a communication session.

Based on information in the received digital certificate (e.g., a common name of the server), the intermediary selects an appropriate operational configuration for responding to the client's request. Illustratively, the intermediary consults an ordered list or other collection of digital certificates it possesses, and chooses one having a common name that matches the server's common name. The match may comprise the first matching name, the longest match, the best match, the broadest match (e.g., a certificate having a name that includes one or more wildcard characters), etc.

The intermediary then uses the selected certificate (and corresponding private key) to establish a secure communication session with the client. The client is thus provided with a secure communication connection that is split-terminated at the intermediary.

### BRIEF DESCRIPTION OF THE DRAWINGS

FIG. 1 is a block diagram depicting an environment in which an intermediate network device is configured to support split-termination of secure communication connections between a client and a server, according to some embodiments of the invention.

FIG. 2 is a time sequence diagram demonstrating a handshaking process for establishing a split-terminated secure communication session at a server side intermediary, according to some embodiments of the invention.

### DETAILED DESCRIPTION OF ILLUSTRATIVE EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In embodiments of the invention described herein, an effective configuration is selected for a network intermediary designed to intercept and terminate secure communication sessions between clients and one or more servers. The configuration includes an appropriate digital certificate, the selection of which depends on which server is being supported, and a corresponding private key.

In these embodiments, a client-server communication connection protected in accordance with a secure communication protocol (e.g., SSL or Secure Sockets Layer, TLS or Transport Layer Security) may be split-terminated at the intermediary in order to enable optimization of the underlying communications (e.g., via transaction acceleration). Although these embodiments implement SSL or TLS, similar methods for use with other secure communication protocols may be derived from the following discussion without exceeding the scope of the current invention.

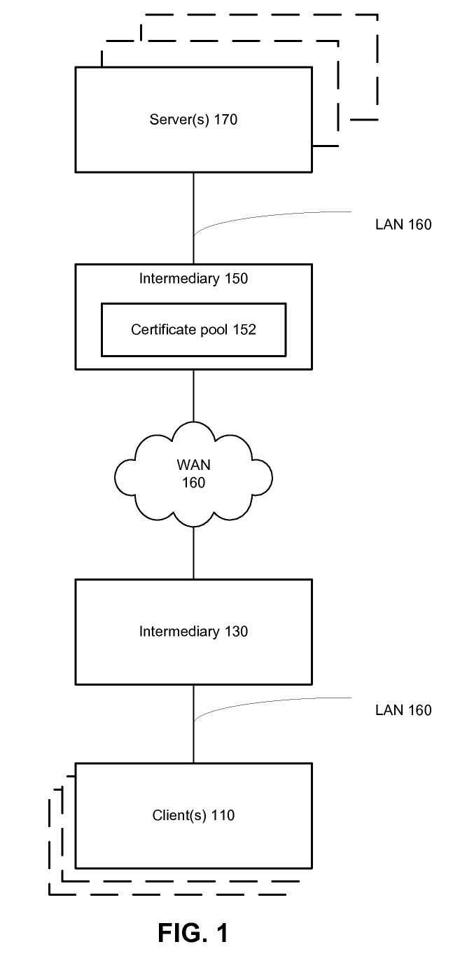

FIG. 1 illustrates an environment in which a network intermediary is configured to support split-terminated secure communication sessions, according to some embodiments of the invention.

In this environment, clients 110 communicate with servers 170 in a client-server relationship. Intermediaries 130, 150 are situated in a path of communications between clients 110 and servers 170.

Intermediaries 130, 150 are coupled to WAN (Wide Area Network) 140, while clients 110 are coupled to intermediary 130 via LAN or LANs (Local Area Networks) 120 and server 170 is coupled to intermediary 150 via LAN or LANs 160. Thus, intermediary 130 is relatively local to clients 110, while intermediary is local to servers 170 (e.g., within the same data center).

In the embodiment of FIG. 1, WAN 140 is characterized by relatively high latency and low bandwidth in comparison to LANs 120, 160. In other embodiments of the invention, other types of communication links may be employed. For example, LANs 120 and/or LANs 160 may be WANs.

Intermediary 130 may be termed a “client side intermediary” (or CSI) and intermediary 150 may be termed a “server side intermediary” (or SSI) to reflect their relative positions within environment 100. Although not shown in FIG. 1, additional client side intermediaries may also cooperate with server side intermediary 150, and/or client side intermediary 130 may cooperate with other server side intermediaries.

In one particular embodiment of the invention, intermediaries 130, 150 are Steelhead™ transaction accelerators from Riverbed® Technology, and are configured to optimize communications and applications (e.g., through compression or acceleration). In other embodiments, the intermediaries may be configured to perform other operations in addition to or instead of optimization, such as routing, caching, etc.

All communication traffic between clients 110 and servers 170 may traverse intermediaries 130, 150 in the illustrated embodiment of the invention. One or both intermediaries may also handle traffic between clients 110 and entities other than servers 170, and/or traffic between servers 170 and other entities. In other embodiments, the clients and servers may also employ other communication paths that skip one or both of the intermediaries.

Each server 170 possesses a valid digital certificate that, among other things, identifies the server and contains the server's public key for use in a PKE (Public Key Encryption) scheme. The server also possesses the corresponding private key. Clients 110 have received, verified and trust a digital certificate of the authority that signed the server's certificate.

It may be noted that no special application, utility or plug-in need be installed on clients 110 in order for them to benefit from embodiments of the invention described herein.

Because the intermediaries cooperate with multiple clients 110 and multiple servers 170, they must be able to terminate client communication sessions regardless of which server a particular client wants to communicate with.

In some embodiments of the invention, SSI 150 must be able to proxy for each server for which it should terminate client communication sessions. To do so it must have access to a digital certificate that identifies the SSI with the same name as the server for which it will proxy, as well as the private key associated with the certificate. Thus, selecting an appropriate configuration for the intermediary to terminate a secure communication connection for SSL or TLS may involve selecting a suitable certificate (and associated private key).

Therefore, server side intermediary 150 maintains pool 152 of digital certificates issued by one or more certificate authorities trusted by clients 110 (e.g., the same authority that issued a server's certificate). For each server 170, certificate pool 152 includes at least one certificate issued in a name that matches the server's name.

One manner of configuring intermediary 150 and certificate pool 152 to support multiple servers could involve loading copies of each server's certificate(s) and private keys to the intermediary. The certificates could then be indexed by the originating servers' network addresses (e.g., IP or Internet Protocol addresses) and possibly the port numbers they use (e.g., port 443 for SSL connections).

When the intermediary needs to proxy for a given server, to terminate a client request for a secure communication connection for example, it would select a certificate and private key based on the address/port to which the client request is targeted. However, this would require the intermediary to possess at least one certificate for each server and could be very inefficient.

For example, this scheme requires an administrator to actively identify every actual or possible address (and port) a server may use, and update the index to reflect all address changes, server additions, port re-mappings, etc.

Further, because servers sometimes change addresses (e.g., to promote load balancing), multiple table entries may be required for one server. For example, when multiple servers cooperate to provide a service (e.g., via HTTPS) and load balancing is applied, a given IP address associated with the service may be rotated among the servers.

Yet further, even if more than one server could be represented with a given certificate (e.g., a certificate having a wildcard name pattern), separate table entries would still be required for each server because of differing addresses and ports.

Another scheme for configuring intermediary 150 to terminate a secure communication session could involve performing a reverse DNS (Domain Name System (or Service)) lookup based on a server address (e.g., IP address) specified in a client's CONNECT request, to find a server's common name and determine which certificate to use. However, many variations of a given hostname (e.g., “company”) are possible—such as www1.company.com, www2.company.com, and so on—as well as CNAME records such as web.company.com, company.com, etc.

Thus, determining which digital certificate an intermediary should use to proxy for a given server while intercepting and terminating a client request for a secure communication connection can be problematic when attempting to do so based on the server's network address or a client's connection request.

Therefore in some embodiments of the invention, when an intermediary intercepts a client request for a secure communication connection (e.g., via SSL or TLS), it postpones proxying for the specified server and terminating the connection until it receives information from the server that will be used to choose an appropriate certificate (and associated private key).

More specifically, after intercepting a client request the intermediary will initiate a handshaking session with the server to begin setting up its own secure communication session. During the handshaking process it will determine which certificate the server elects to use, and the intermediary can then choose a suitable candidate from its pool of certificates.

In this embodiment of the invention, and with reference to FIG. 1, certificate pool 152 is an ordered list of digital certificates, and server side intermediary 150 also maintains corresponding private keys for the certificates. The SSI need not index the certificates by IP (or other) addresses of the servers, by destination port numbers or other criteria.

When it receives a server's certificate during the handshaking it commenced after intercepting a client connection request, it examines the common name (CN) of the certificate and searches its pool for a match. A certificate from the pool may be selected on the basis of first match, longest match, closest match, etc. Any number of certificates in the pool may have wildcard names, meaning that their common names include one or more wildcard characters (e.g., “*”).

In other embodiments of the invention, other attributes, fields or extensions from a server's certificate may be used to select a matching certificate at the intermediary. For example, the intermediary could use a network address or email address extracted from the server's certificate.

In one implementation of this embodiment, in which the common names of servers 170 can all be matched with a single wildcard certificate (e.g., issued in the name *.company.com), the intermediary may be able to proxy for all the servers with just that one certificate (and corresponding private key).

Because the intermediary's configuration does not depend on the servers' network addresses or the ports they use, server addresses and ports can be changed (e.g., for load balancing) without affecting the intermediary's configuration or method of operation.

Another advantage of this method of configuring the network intermediary is that it is sensitive to any special scheme a server may apply for selecting a certificate. For example, if the server selects a particular certificate based on a client's location (e.g., country), type of browser or other factor, the certificate subsequently selected by the intermediary will reflect the server's operation.

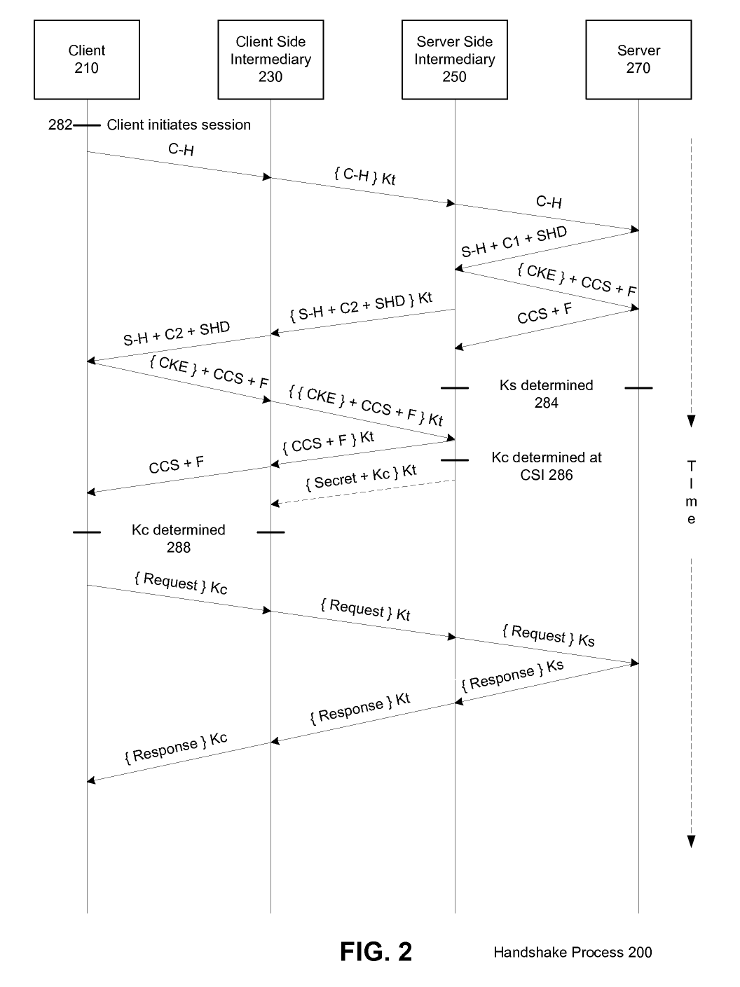

FIG. 2 is a time sequence diagram illustrating protocol handshaking that may be performed to allow a pair of intermediaries to intercept and terminate a client request for a secure communication connection with a server, according to an embodiment of the invention. During that handshaking an intermediary selects a suitable configuration (e.g., certificate and private key) based on information received form the server.

Instead of establishing one end-to-end connection between the client and the server, the connection will comprise multiple separate sessions, such as one between the client and an intermediary and a second between the server and the same or different intermediary. The intermediaries may also establish a secure session between themselves.

In FIG. 2, client 210 communicates with client side intermediary (CSI) 230 via a LAN, CSI 230 communicates with server side intermediary (SSI) 250 via a WAN, and SSI 250 communicates with server 270 directly or via another LAN. The directed vectors between these entities represent messages involved in handshaking process 200.

In this embodiment, at time sequence 282 the client initiates a secure communication connection. For purposes of clarity, data exchanges between protocol layers up through the transport protocol layer (e.g., TCP) are omitted so that the discussion can be focused on the SSL/TLS handshaking process.

After time sequence 282, or possibly in advance of time sequence 282, CSI 230 and SSI 250 establish a secure channel or tunnel between them, so that communications exchanged across the WAN are protected. In one implementation they employ SSL to establish a symmetric key (with either intermediary acting as client), although in other implementations they may employ a different security scheme. A symmetric key used by the CSI and SSI to encrypt/decrypt messages sent via the tunnel may be represented herein as Kt.

When the client initiates the secure session, it issues an SSL Client-Hello (C-H) message toward the entity to which it wishes to submit a data request—server 270. The Client-Hello message comprises a client-based seed that will serve as one component in the production of a master secret for use in generating a key for the client's session.

The absence of curly braces “{” and “}” around the Client-Hello message indicates that the message is sent as clear text. The Client-Hello message is subsequently encrypted by CSI 230 and forwarded to SSI 250. This message is represented in FIG. 2 as “{C-H} Kt” to indicate that it is encrypted using the intermediaries' key Kt.

SSI 250 decrypts the Client-Hello message (with Kt) but, instead of forwarding the client's hello message to server 270, it generates and issues its own Client-Hello message (C-H) acting as client 210. This initiates an SSL handshaking process between the SSI and the server. In an alternative embodiment of the invention, instead of generating a new Client-Hello message, the SSI simply forwards the hello message it received from the CSI, or at least includes the client-based seed in its Client-Hello.

In response to whichever Client-Hello message the SSI issues, the server sends a clear text message comprising Server-Hello (S-H), a digital Certificate (C1) belonging to the server (which includes a public asymmetric key) and Server-Hello-Done (SHD). The Server-Hello message comprises a server-based seed that will be another component in the production of a master secret for a secure session between SSI 250 and server 270.

SSI 250 responds with a message signaling Client Key Exchange (CKE) (comprising a secret encrypted with the server's public asymmetric key), Change-Cipher-Specification (CCS) (to specify that the communicants are to start encrypting their communications using a key derived from the master secret) and Finished (F) (which includes an encrypted hash of the communicants' handshaking messages). Server 270 completes the handshaking by signaling CCS and F.

As a result of the handshaking between SSI 250 and server 270, at time sequence 284 both entities possess symmetric key Ks, which will be used to encrypt and decrypt communications between them. Note that in a communication environment in which the link between the SSI and the server is fully secured and trusted, server side intermediary 250 may cancel the handshaking after receiving certificate C1. The SSI will then have the information it needs to select a certificate for establishing a session with the client, and the SSI and server may subsequently communicate in the clear.

Some time after receiving certificate C1 (possibly after time sequence 284), the server side intermediary now proxies for server 270 with regard to the original Client-Hello message issued by client 210. Specifically, the SSI responds with Server-Hello (S-H), a certificate (C2) identifying SSI 250 with a name that matches the common name of server 270 within certificate C1, and Server-Hello-Done (SHD). The client side intermediary decrypts this response with Kt and forwards it to the client. The Server-Hello sent by SSI 250 may or may not comprise the server-based seed received by the SSI from server 270.

Client 210 responds with Client-Key-Exchange (CKE) (including a client secret encrypted with an asymmetric key extracted from certificate C2), Change-Cipher-Specification (CCS) and Finished (F). The CSI encrypts this response with Kt and forwards it to SSI 250. The SSI completes the handshaking by signaling CCS and F, which are decrypted by the CSI and delivered to the client.

Therefore, at time sequence 286 server side intermediary 250 has computed symmetric key Kc, which can be used to encrypt communications from and to the client. Client 210 similarly possesses Kc at time sequence 288, at the completion of the handshaking procedure with the SSI.

In the embodiment of the invention depicted in FIG. 2, after SSI 250 computes a master secret and key Kc from the client's secret, client-based seed and server-based seed, it may forward key Kc (and possibly the master secret) to the client side intermediary via their secure tunnel. Thus, within a short time after the handshaking between the client and the SSI, both the client and CSI 230 are ready to use Kc, and communications from the client may be decrypted at either CSI 230 or SSI 250.

In one alternative implementation of this embodiment of the invention, SSI 250 forwards only the master secret to CSI 230, and the CSI computes Kc. In other implementations, other security may be applied to protect the client secret and/or master secret in transit between the SSI and the CSI.

In yet another alternative implementation, key Kc (and possibly the master secret) may be sent from the SSI to the CSI as part of the message conveying Change-Cipher-Specification (CCS) and Finished (F). Or, neither key Kc nor the master secret may be provided to the CSI.

After time sequence 288, the client may now issue data requests toward server 270. A client request is encrypted using Kc and submitted to CSI 230, where it is decrypted using the same key. The request is then encrypted using Kt, forwarded to SSI 250 and decrypted with the same key. Alternatively, in an implementation in which the SSI does not supply key Kc to the CSI, CSI 230 may simply relay the data request to SSI 250.

Finally, the SSI encrypts the request with Ks and delivers it to server 270 for decryption and subsequent action. The reverse process is then followed to securely deliver the server's response to client 210.

Although not completely shown in FIG. 2, each CKE message is encrypted with the public key of the server or other entity (e.g., SSI 250) to whom the CKE message is directed, and will be decrypted using the corresponding private key.

In FIG. 2, time sequences 282, 284, 286 and 288 are not intended to represent the exact moments the indicated keys become available for use by the corresponding communicants. Such moments may occur before, after or even during the transmission or receipt of messages represented by directed vectors proximate to these time sequences.

In an embodiment of the invention, client side intermediary 230 may only intercept those Client-Hello messages (or other requests for communication connections) that match certain criteria. For example, it may be configured to apply a rule requiring it to intercept all traffic destined to a particular port (e.g., 443).

As another example, the CSI may be configured to intercept all TCP SYN packets, which are used to initiate TCP communication connections. The CSI may mark such packets as probes (e.g., by setting or clearing a particular TCP option) before forwarding them to the server side intermediary.

At the SSI, a probe will be interpreted as a query regarding whether or not a communication connection between the client and the target server can be optimized. When the SSI receives a probe, if it does not already know about the target server it may initiate a discovery handshaking process with that server (while acting as the client) in order to obtain the server's certificate, then determine whether it has a matching certificate.

The SSI will respond affirmatively to a probe if the SSI can proxy for the target server (e.g., it has a matching certificate and corresponding private key), and negatively if it cannot. If the SSI cannot proxy for the target server, it may simply forward the server's response toward the client and let it complete the handshaking without further interference.

If the CSI never receives a response to a particular probe then it may assume that the SSI is not even in the path of communication to the server, and cease attempts to intercept and/or optimize traffic to that server. Thus, the CSI may maintain a list of excluded servers for which it will not intercept connection attempts. Entries in this list may or may not expire or be purged over time.

In some embodiments of the invention, a discovery process implemented by the server side intermediary manipulates certain data structures to determine whether to attempt to establish a connection with a given server/port or to remember servers/ports that it can communicate with. A first structure comprises a table of “peering rules” the SSI may apply to determine whether or not it should even attempt to make contact with (i.e., discover) a new server—such as a server identified in a probe received from a CSI.

An illustrative rule may specify that the SSI should make discovery attempts for TCP connection requests directed to secure ports (e.g., port 443), but not make attempts for requests directed to non-secure ports. Another rule may require the SSI to filter attempted discoveries for requests to secure ports to exclude requests directed to servers/ports with which the SSI already knows it cannot establish a communication connection. These servers/ports (which may be identified by IP address and port (or other indicia)) may be included in the “blacklist” described below.

One or more other data structures are configured to record the results of discovery attempts. Illustratively, a “server status” table comprises the blacklist (identifying those servers/ports to be shunned) as well as a “whitelist” that identifies servers/ports with which the SSI can establish a communication connection.

The whitelist also comprises links to the ordered list (or other structure) that comprises the certificate pool. In particular, each server/port in the whitelist may be accompanied by one or more links or pointers into the certificate pool, with each link referencing a digital certificate and private key for establishing a secure communication session with the server/port.

Thus, when a new server/port is discovered, it is added to the whitelist along with a reference to a suitable certificate (and private key). The reference allows the certificate to be accessed rapidly the next time that server/port is targeted. Multiple entries in the whitelist may comprise references to a given certificate in the certificate pool.

In an embodiment of the invention, some or all of these data structures, such as the whitelist, blacklist, server status table, table of peering rules and certificate pool, may be replicated at a client side intermediary. In other embodiments some may reside on one intermediary and some may reside on another.

In some embodiments of the invention, a process described above for identifying target servers for which the intermediaries can optimize communication sessions can be used to optimize communications (secured or unsecured) that traditionally are not optimized. For example, a communication stream carrying a filesystem operation or electronic mail message may not typically be encrypted end-to-end between a client and a server. However, if the intermediaries are located in this stream, they may nonetheless intercept and encrypt the communication for at least part of its journey (e.g., across a WAN), and/or optimize it in some way.

The environment in which a present embodiment of the invention is executed may incorporate a general-purpose computer or a special-purpose device such as a hand-held computer. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of configuring a network intermediary to facilitate establishment of a split-terminated secure communication connection between a client computing device and a server computing device, the method comprising:
intercepting a first request from the client for a secure communication session with a first server;
issuing to the server a substitute request for a secure communication session;
receiving from the first server a first digital certificate comprising a first indicia of the first server;
selecting from a set of digital certificates a second digital certificate having a second indicia that matches the first indicia; and
transmitting the second digital certificate toward the client to facilitate establishment of a first secure communication session between the client and the network intermediary.

2. The method of claim 1, wherein the first indicia and the second indicia comprise names.

3. The method of claim 1, wherein the first indicia and the second indicia comprise addresses.

4. The method of claim 1, further comprising, after said receiving from the first server a first digital certificate:
establishing a second secure communication session between the network intermediary and the first server.

5. The method of claim 1, wherein:
said set of digital certificates comprises an ordered list; and
said selecting comprises selecting the first certificate in said ordered list having an indicia that matches the first indicia.

6. The method of claim 1, wherein:
said set of digital certificates comprises an ordered list; and
said selecting comprises selecting the last certificate in said ordered list having an indicia that matches the first indicia.

7. The method of claim 1, wherein:
said set of digital certificates comprises an ordered list; and
said selecting comprises selecting a certificate in said ordered list having an indicia that best matches the first indicia.

8. The method of claim 1, wherein:
said set of digital certificates comprises an ordered list; and
said selecting comprises selecting a certificate in said ordered list having a longest indicia that matches the first indicia.

9. The method of claim 1, wherein:
said set of digital certificates comprises an ordered list; and
said selecting comprises selecting a certificate in said ordered list having a wildcard indicia that matches the first indicia.

10. The method of claim 1, wherein the substitute request comprises the first request.

11. The method of claim 1, wherein the substitute request comprises a client-based seed included in the first request.

12. The method of claim 1, wherein for each of multiple servers, including the first server, the set of digital certificates includes at least one digital certificate having a name that matches a name of the server.

13. A computer-readable medium storing instructions that, when executed by a computer, cause the computer to perform a method of configuring a network intermediary to facilitate establishment of a split-terminated secure communication connection between a client computing device and a server computing device, the method comprising:
intercepting a first request from the client for a secure communication session with a first server;
issuing to the server a substitute request for a secure communication session;
receiving from the first server a first digital certificate comprising a first indicia of the first server;
selecting from a set of digital certificates a second digital certificate having a second indicia that matches the first indicia; and
transmitting the second digital certificate toward the client to facilitate establishment of a first secure communication session between the client and the network intermediary.

14. A network configured to optimize secure communications between a client and a plurality of servers, the network comprising:
a server-side intermediary installed in a communication path between the client and the plurality of servers, wherein the server-side intermediary comprises:
an ordered list of digital certificates associated with names of the plurality of servers, wherein each certificate in the ordered of digital certificates enables the server-side intermediary to proxy for at least one of the servers and establish a first secure communication session with a client; and
for each certificate in the ordered list of digital certificates, a corresponding private key; and
a client-side intermediary installed in the communication path and coupled to the server-side intermediary by a wide area network, wherein the client-side intermediary is configured to intercept and forward to the server-side intermediary client requests for secure communication connections.

15. A network intermediary configured to facilitate establishment of a split-terminated secure communication connection between a client computing device and any one of a plurality of server computing devices, the network intermediary comprising:
an ordered list of digital certificates, wherein for each of the plurality of server computing devices, the ordered list includes at least one digital certificate having an attribute that matches an attribute of the server;
for each digital certificate in the ordered list of digital certificates, a private key corresponding to the public key included in the digital certificate;
a whitelist identifying the plurality of server computing devices and comprising, for each of the server computing devices, a link to a compatible digital certificate in said ordered list of digital certificates.

16. The network intermediary of claim 15, further comprising:
a blacklist configured to identify at least one other server computing device for which no compatible digital certificate is included in said ordered list of digital certificates.

17. The network intermediary of claim 15, further comprising:
a collection of rules configured to specify whether the network intermediary should attempt to establish a secure communication session with a given server computing device not identified in said whitelist.

18. The network intermediary of claim 15, wherein the attribute comprises a name.

19. The network intermediary of claim 15, wherein the attribute comprises an address.

20. The network intermediary of claim 15, further comprising:
a first communication port configured to receive a request from the client for a secure communication session with a first server in the plurality of server computing devices;
a second communication port configured to:
issue to the first server a substitute request for a secure communication session with the first server; and
receive from the first server, during a handshaking process for establishing the secure communication session with the first server, a first digital certificate referring to the first server with a first attribute; and
a processor configured to select from the ordered list of digital certificates, a second digital certificate having a second attribute that matches the first attribute;
wherein the first communication port is further configured to transmit the second digital certificate toward the client to facilitate establishment of a secure communication session between the client and the network intermediary.
